(19) United States
(12) Patent Application Publication
(10) Pub. No.: US 2013/0314443 A1
(43) Pub. Date: Nov. 28, 2013

(54) METHODS, MOBILE DEVICE AND SERVER FOR SUPPORT OF AUGMENTED REALITY ON THE MOBILE DEVICE

(71) Applicant: Clayton GRASSICK, (US)

(72) Inventor: Clayton GRASSICK, (US)

(21) Appl. No.: 13/893,811

(22) Filed: May 14, 2013

Related U.S. Application Data
(60) Provisional application No. 61/652,254, filed on May 28, 2012.

(51) Int. Cl. G06T 11/60

(52) U.S. Cl. CPC G06T 11/60
USPC 345/633

(57) ABSTRACT

The present disclosure relates to methods, to a mobile device and to a server for support of augmented reality on the mobile device. The mobile device acquires a current image of its environment. The mobile device determines its orientation and its location by comparing the current image with reference image information related to an estimated location of the mobile device. The mobile device may provide information about new, modified or missing reference image features, for a given location, to a server. The server may then update a corresponding reference image feature in a local database.

### TECHNICAL FIELD

The present disclosure relates to the field of augmented reality. More specifically, the present disclosure relates to methods, to a mobile device and to a server for support of augmented reality on the mobile device.

### BACKGROUND

Augmented reality is a very active field of research. Use of augmented reality for advertising suggests a staggering potential. In an application example, a live image of a storefront could be overlaid with full, three-dimensional information providing, in real-time, information of interest tailored to a particular viewer. Information could be displayed on top of, and aligned with, a live camera image visible on a display of a mobile device. For this and other similar applications to meet their full potential, precise location and orientation of a mobile device, provided in real-time, becomes necessary.

Current location-finding methods for mobile devices do not provide sufficient granularity for efficient support of augmented reality applications. For example, the Global System Positioning (GPS) system provides, for civilian applications, accuracy in the range of a few meters. GPS accuracy may be reduced by a number of factors, including line-of-sight with a small number of GPS satellites when a receiver is located in a dense urban area.

Therefore, there is a need for methods and apparatuses that compensate for difficulties in providing location and orientation information of a mobile device for provision of augmented reality information.

### SUMMARY

According to the present disclosure, there is provided a method of determining a pose of a mobile device. The mobile device acquires a current image of an environment of the mobile device. A location and an orientation of the mobile device are determined by comparing the current image with reference image information related to an estimated location of the mobile device.

According to the present disclosure, there is also provided a mobile device comprising a camera and a processor. The camera acquires a current image of an environment of the mobile device. The processor determines a location and an orientation of the mobile device by comparing the current image with reference image information related to an estimated location of the mobile device.

According to the present disclosure, there is also provided a method of maintaining reference image information. A server stores reference image information in association with corresponding location information. An indication of a new, modified or missing reference image feature for a given location is received from a mobile device. The new, modified or missing reference image feature corresponding to the given location is incorporated in the server.

The present disclosure further relates to a server comprising a database, a communication interface and a processor. The database stores reference image information in association with corresponding location information. The communication interface receives an indication of a new, modified or missing reference image feature for a given location. The processor incorporates, in the database, the new, modified or missing reference image feature corresponding to the given location.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 shows a sequence of steps for determining a pose of a mobile device;

FIG. 2 shows a sequence of steps for maintaining reference image information;

FIG. 3 is a block diagram of a mobile device according to an embodiment;

FIG. 4 is a block diagram of a server according to an embodiment; and

FIG. 5 is a block diagram of a system comprising the mobile device of FIG. 3 and the server of FIG. 4.

### DETAILED DESCRIPTION

Like numerals represent like features on the various drawings. Various aspects of the present disclosure generally address one or more of the problems of providing location and orientation information of a mobile device for provision of augmented reality information.

The following terminology is used throughout the present disclosure:
Pose: a combination of a geographical location and orientation of an object or an image.
Mobile device (MD): a portable device having processing and communication capabilities, generally for use by a person.
Current image: image obtained in real-time by a mobile device.
Orientation: angular position against a set of references, for example an angle relative to the horizon or relative to polar coordinates.
Sensor: a device that provides a response to a stimulus.
Estimated location: approximate geographical location.
Location: geographical position obtained with more accuracy than an estimated location.
Reference image: image associated with a location and an orientation.
Image feature: a subset of an image, or a mathematical derivation of an image, the image feature being easily distinguishable within the image.
Reference image feature: an image feature that is visible in one or more reference images; location information, including but not limited to its specific three dimensional (3-D) location, may also be known.
Server: a computer in a network that provides a service.
Kalman filter: a well-known estimation filter, including linear and non-linear variations thereof.
Augmented reality: sensory input added to an image, video, sound, and the like, for providing context.
Camera: any device capable of capturing an image.
Processor: electronic module for performing mathematical and logical operations.
Memory: electronic module for storing information.
Transmitter: device capable of sending an electrical, optic or radio signal.
Receiver: device capable of receiving an electrical, optic or radio signal.
Display: electronic module for showing images.
Database: device having a memory for permanently or semi-permanently storing information.
Communication interface: device capable of sending and receiving electrical, optic or radio signals.
Timer: electronic module for providing timing values.
Operably connected: directly or indirectly connected in a functional manner.

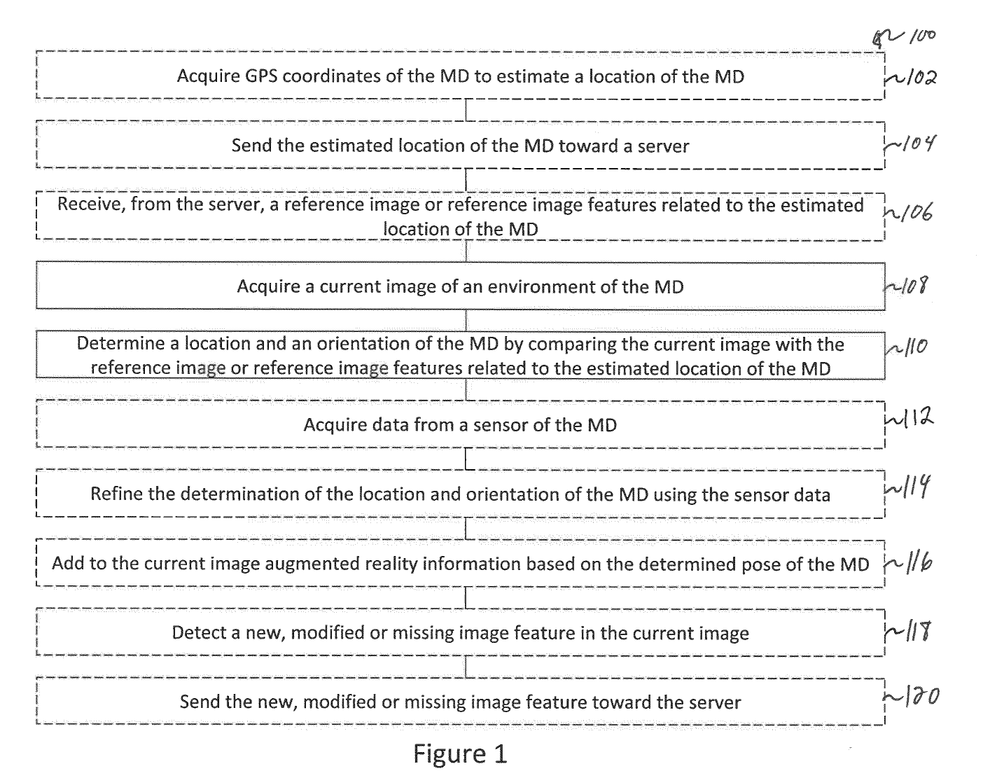

Referring now to the drawings, FIG. 1 shows a sequence of step for determining a pose of a mobile device. A sequence 100 comprises a number of steps implemented in a mobile device (MD). Some of the steps of sequence 100 may not be present in some embodiments, some of the steps may be merged, and some of the steps may occur in a different sequence from that shown on FIG. 1. The sequence 100 as shown is therefore provided as an example and is not limiting. The sequence 100 may start at step 102 by an acquisition of global positioning system (GPS) coordinates of the MD to estimate the location of the MD. Other methods of providing an estimated location of the MD, for example by data entry by a user of the MD or by wired or wireless connection to a local server, may also be contemplated. The MD may send, at step 104, its estimated location toward a server. In response at step 106, the MD may receive, from the server, reference image information related to the estimated location of the MD. Steps 104 and 106 may not be present when the MD has previously stored the reference image information related to its estimated location, either upon a previous access at that location or by loading a bank of reference images in a memory of the MD.

Whether previously stored in the MD or received from the server at step 106, the reference image information may comprise complete images or a subset thereof. Alternatively, the reference image information may comprise reference image features that have been extracted from one or more reference images. In the context of the present disclosure, the MD may use complete reference images or may use one or more partial reference images or may use reference image features for pose determination.

At step 108, the MD acquires a current image of its environment. This may be accomplished using a camera integrated in the MD or using a camera that is operably connected to the MD. The MD then determines its location and orientation at step 110. Determination of the location and orientation of the MD may be done in a processor of the MD by comparing the reference image, or the reference image features, with the current image. The orientation and the location of the MD constitute the pose of the MD. The pose may be determined in real-time.

In an embodiment, determination of the pose of the MD may be facilitated and refined with the help of a sensor, for example an internal sensor of the MD, which provides supplemental data to the processor of the MD at step 112. The determination made at step 110 of the location and orientation of the MD may thus be refined at step 114, using sensor information. Use of sensor information may improve accuracy and/or reduce latency of the pose estimation. Supplemental data obtained via one or more sensors may comprise, without limitation, information related to a movement, a rotation, an acceleration and a deceleration of the MD. In a variant, the MD may comprise one or more sensors to provide an angular position of the MD relative to the horizon, an orientation of the MD relative to the magnetic North, an acceleration of the MD, an angular velocity of the mobile device, or any combination of these parameters.

Though FIG. 1 shows steps 110 and 114 as consecutive steps, another embodiment may combine these two steps in a single pose determination step. For example, the MD may apply a Kalman filter to information derived from images, possibly adding data from the sensors, to determine the pose of the MD. Alternatively, the MD may apply any linear or non-linear estimator known in the art to filter the image information and the data from the sensors.

At step 116, the MD may add to the current image augmented reality information based on the determined pose of the MD. The reality information may be received from the above mentioned server, from a distinct server, or may be preloaded in the memory of the MD.

Features of a reference image may not be up-to-date, especially when a given reference image has been captured and loaded for an extended period of time. Permanent changes to the environment may have occurred and some reference image features may be inconsistent with the current image. Consequently, the MD may detect, at step 118, a new, modified or missing image feature in the current image. The MD may then send information about the new, modified or missing image feature toward the server at step 120.

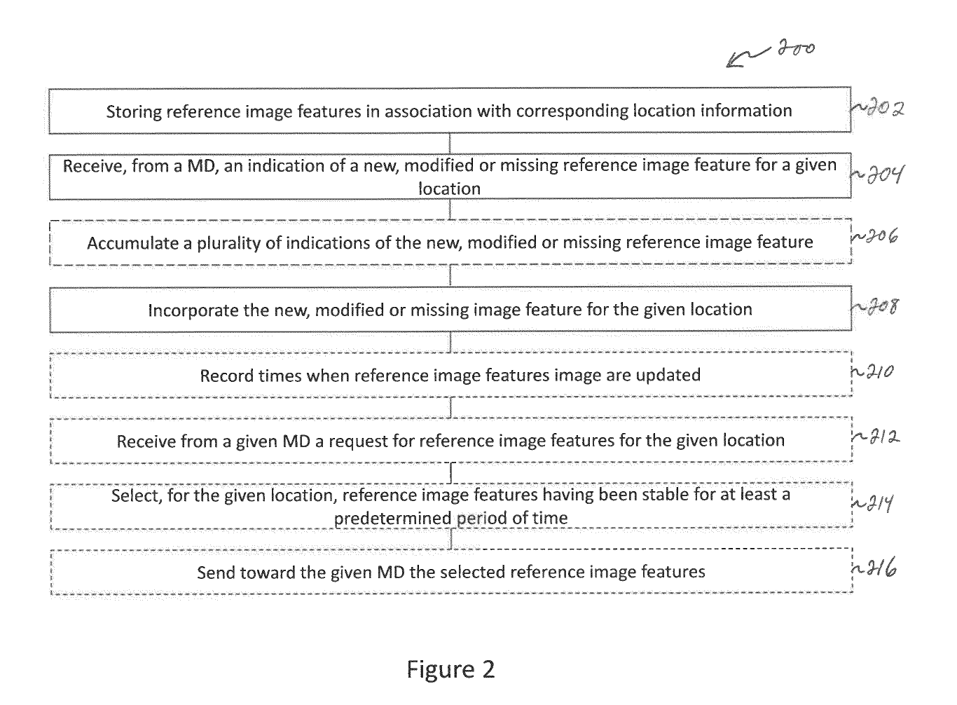

FIG. 2 shows a sequence of steps for maintaining reference image information. A sequence 200 comprises a number of steps implemented in a server. Some of the steps of sequence 200 may not be present in some embodiments and some of the steps may occur in a different sequence from that shown on FIG. 2. The sequence 200 as shown is therefore provided as an example and is not limiting.

The sequence 200 may start at step 202 by storing, in the server, reference image information in association with corresponding location and orientation information. In particular, reference image information may comprise a complete reference image or a number of reference image features. A non-limiting example of suitable reference images associated with location information may comprise StreetView™ information from Google™. In this example, reference images features associated with geographical coordinates are extracted from the reference images and may be used in a MD for comparison with images acquired by the MD. At step 204, the server receives, from a mobile device (MD), an indication of a new, modified or missing reference image feature for a given location. In order to increase the reliability of such information, the server may, at step 206, accumulate a plurality of indications of the new, modified or missing reference image feature, the plurality of indications being received from MDs proximate to the given location. The server then updates a given reference image feature corresponding to the given location at step 208. In a variant, incorporation of a new, modified or missing reference image feature may follow reception of a predetermined number of indications from MDs. In another variant, incorporation of a new, modified or missing reference image feature may follow reception of the predetermined number of indications from a predetermined number of distinct MDs.

The server may, at step 210, record times when given reference image features of the given reference image are updated. Thereafter, the server may receive from a particular MD a request for reference image features for the given location at step 212. The server may select, at step 214, for the given location, reference image features having been stable for at least a predetermined period of time, as determined on the basis of recorded times of updates. The server may then, at step 216, send toward the particular MD the selected reference image features. Those of ordinary skill in the art will appreciate that, from a practical standpoint, the server may associate reference images or reference image features with location information defined at a first level of granularity and that the given location in the MD indication of step 204 or in the MD request of step 212 may be provided at a second level of granularity. Updating of reference image features at step 208 and selection of reference image features at step 216 may rely on a search by the server for a best match of location information provided at various accuracy levels.

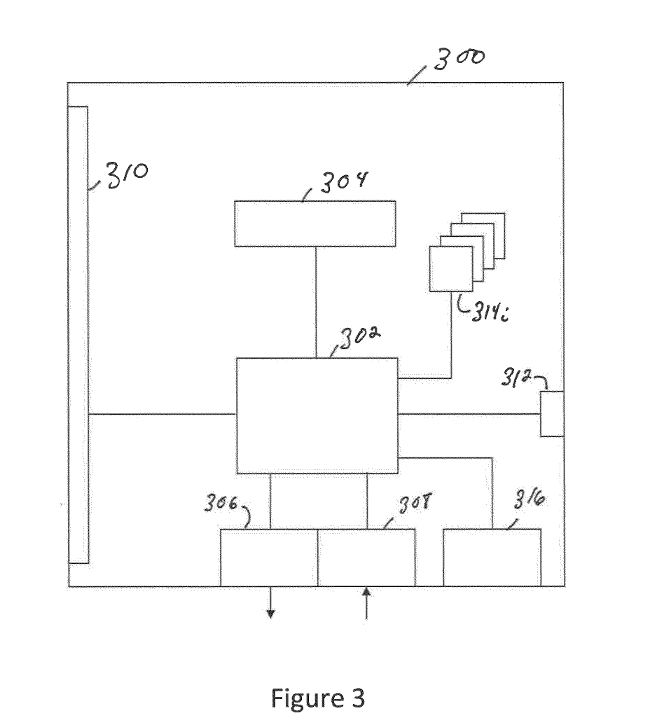

FIG. 3 is a block diagram of a mobile device according to an embodiment. Variants of a MD 300 as shown on FIG. 3 may comprise, without limitation, a cellular terminal, an intelligent mobile terminal, a personal digital assistant (PDA), a personal computer, a tablet computer, a MP3 player, and like portable devices having processing and communication capabilities. The MD 300 as shown comprises a processor 302 associated with a memory 304. A transmitter 306 and a receiver 308, which may be substituted by a transceiver, provide bi-directional wired or wireless communication capabilities to the MD 300. The transmitter 306 and the receiver 308 may support a cellular interface, a wireless local area network (WLAN) interface, a WiMAX interface, or any combination thereof. The MD 300 may also comprise a display 310, a camera 312, one or more sensors 314ᵢ, and a GPS receiver 316. The processor 302 is operably connected to all elements of the MD 300 and generally controls operation of the device. Some embodiments of a MD 300 may only comprise a subset of the elements of FIG. 3, which is provided as an example without limiting the present disclosure. The MD 300 may further comprise a keyboard, a universal serial bus (USB) connector, a battery, a microphone and a loudspeaker, as is well-known to those skilled in the art.

In operation of the MD 300, the camera 312 acquires a current image of an environment of the MD 300. The processor 302 determines a location and orientation of the MD 300 by comparing the current image with reference image features related to an estimated location of the MD 300. The processor 302 may then combine this information with supplemental information from one or more of the sensors 314ᵢ to provide a real-time and accurate determination of a pose of the MD 300.

In some embodiments, the processor 302 may add to the current image augmented reality information based on the determined location and orientation of the MD 300. The processor 302 may then request that the display 310 shows the current image with the added augmented reality information.

Various embodiments of the MD 300 may implement one or more optional features. The estimated location of the MD 300 may be obtained from the GPS receiver 316. Alternatively, the location may be obtained via the receiver 308 from a local beacon, for example a WLAN router. The sensors 314ᵢ may comprise an angular position sensor, an accelerometer, a gyroscope, a magnetometer and like sensors. Variants of the processor 302 may determine the pose of the MD 300 in real-time, and may apply a Kalman filter or a similar model estimation technique to information derived from the image and to information from the sensors 314ᵢ to determine the pose of the MD 300. The reference image features related to the estimated location of the MD 300 may be preloaded in the memory 304. Alternatively, the transmitter 306 may send the estimated location of the MD 300 to a server. The receiver 308 may then receive the reference image features from the server and provide them to the processor 302 for comparison with the current image. The Kalman filter or other estimator may, in some embodiments, be used in the comparison of the current image with the reference image features. In a variant, the processor 302 may detect in the current image a new, modified or missing image feature that is inconsistent with the reference image feature. The processor 302 may request the transmitter 306 to send, toward the server, the new, modified or missing image feature.

Generally, the MD 300 may further be configured to execute the functions assigned to the mobile device in the sequences 100 and 200 of FIGS. 1 and 2.

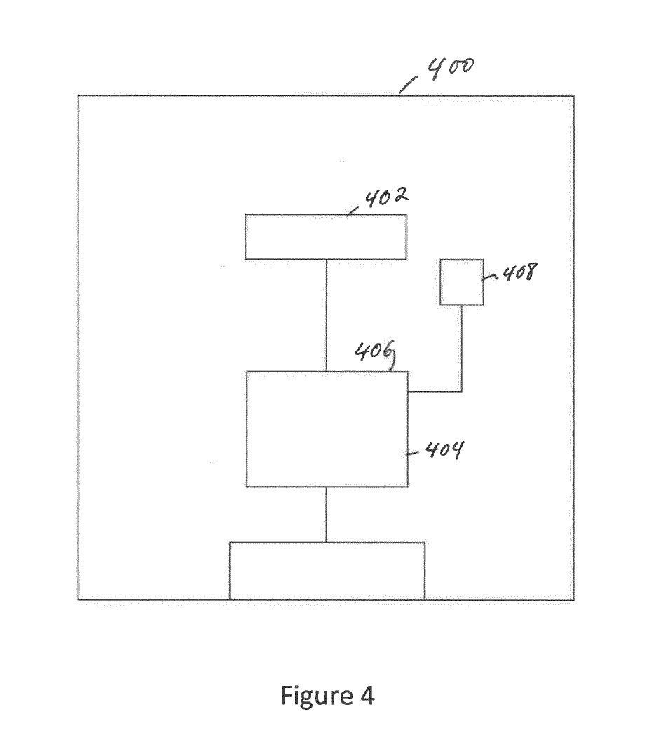

FIG. 4 is a block diagram of a server according to an embodiment. Variants of a server 400 as shown on FIG. 4 may comprise, without limitation, a network server, a web server, a relational database, and like network nodes having storage, processing and communication capabilities. The server 400 may be distributed among a plurality of interrelated physical nodes. The server 400 as shown comprises a database 402, a communication interface 404, a processor 408 and may further comprise a timing module, or timer 408. The communication interface 404 may support a wired or wireless interface for providing bi-directional communication, either directly or through a network, with mobile devices. The communication interface 404 may support a plurality of communication paths and may comprise a plurality of physical communication ports. The processor 402 is operably connected to all elements of the server 400 and generally controls its operation. Some embodiments of a server 400 may only comprise a subset of the elements of FIG. 4, which is provided as an example without limiting the present disclosure. Those skilled in the art will appreciate that the server 400 may further comprise an operator interface, a power supply and like components, and that the server 400 may further be used for other purposes besides those described in the present disclosure.

In operation of the server 400, the database 402 stores reference image information in association with corresponding location information. Image information may comprise complete reference images or may comprise reference image features. Location information may comprise, for example, geographical coordinates including longitude, latitude, altitude and orientation of the reference images and/or of the reference image features. Of course, the geographical coordinates may comprise a subset of these elements, which may be stored at various accuracy levels. The communication interface 404 may receive, from a mobile device, an indication of a new, modified or missing reference image feature for a given location. Location information received by the mobile device may not be at a same accuracy level as in the location information stored in the database 402. The processor 406 may thus need to adapt the received location information in order to find a best match with location information stored in the database 402. Responsive to this indication, the processor 406 may update, in the database 402, a given reference image feature corresponding to the given location. In a variant, the database 402 may accumulate a plurality of indications of the new, modified or missing reference image feature and the processor 406 may refrain from updating the given reference image feature until a predetermined number of indications has accumulated in the database 402. A time value supplied by the timer 408 may be stored in the database 402, along the given reference image feature, in order to record the time when the given reference image feature is updated.

The interface 404 may receive, from a mobile device or from another requesting node, a request for reference image features for a particular location. In response, the processor 406 selects, for a reference image corresponding to the particular location, reference image features having been stable for at least a predetermined period of time, as determined based on the time value associated with features of the reference image. The processor 406 then requests the interface 404 to send the selected reference image features toward the mobile device or toward the requesting node.

Generally, the server 400 may further be configured to execute the functions assigned to the server in the sequences 100 and 200 of FIGS. 1 and 2.

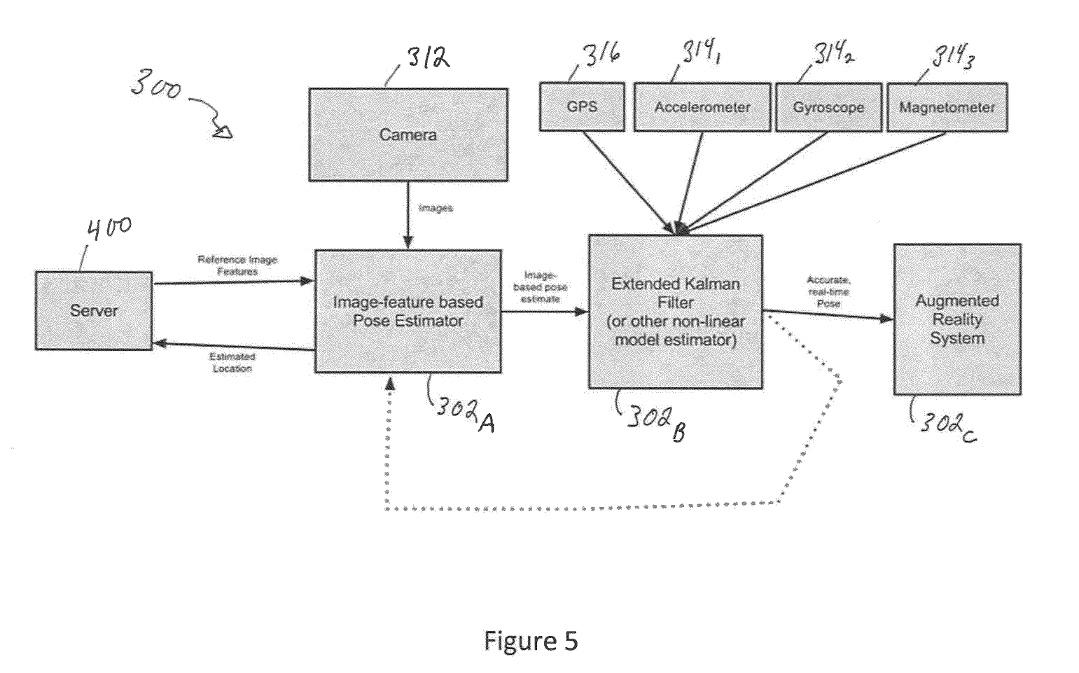

FIG. 5 is a block diagram of a system comprising the mobile device of FIG. 3 and the server of FIG. 4. The MD 300 is in communication with the server 400 and provides an estimated location. The server 400 provides a reference image, or reference image features, related to the estimated location.

Some of the MD 300 components shown on FIG. 5 may or may not be present in various embodiments. Other components of the MD 300 as shown on FIG. 5 may incorporate optional functions that are not present in other embodiments. FIG. 5 therefore represents an example of a particular MD 300 and is not intended to limit the scope of the present disclosure.

The MD 300 comprises the processor 302 incorporating an image-feature based pose estimator 302_{A}, an estimator 302_{B} comprising a Kalman filter, an extended Kalman filter, or another linear or non-linear model estimator, and an augmented reality system 302_{C}. Of course, the features 302_{A}, 302_{B} and 302_{C} of the processor 302 may be implemented in distinct cooperating processors of 302ᵢ the MD 300.

Sensors 314ᵢ as illustrated comprise an accelerometer 314₁, a gyroscope 314₂ and a magnetometer 314₃. Of course, any one of these sensors is optional and other sensors may be present in the MD 300.

The estimator 302_{B}, may be understood as a box into which are fed image-based pose estimates, GPS input and sensor inputs of all kinds. The estimator 302_{B} combines all of these inputs to determine an accurate, real-time pose, which is presented to the augmented reality system 302_{C}. An initial pose estimate may optionally be provided to the image-feature based pose estimator 302_{A} by the estimator 302_{B} to bootstrap the image-based pose determination process, enabling an initial guess of image-features base estimation.

Those of ordinary skill in the art will readily appreciate that determination of the pose of the MD may also be applied to other uses, besides the display of augmented reality information. Various realizations of the methods, MD and server introduced hereinabove are thus not limited to one single type of use but may be applied whenever precise determination of the position of an MD may be sought.

Various embodiments of the methods, mobile device and server, as disclosed herein, may be envisioned. One or more such non-limiting embodiments may comprise a system for mobile devices that determines a mobile device's position and orientation in real-time, with a high degree of accuracy, by using the combination of GPS, magnetic and inertial sensors, and images taken by the mobile device's camera. The images taken by the camera are compared by the mobile device with reference image features stored on a server to determine a precise location of the mobile device.

In some aspects, the present disclosure introduces a service available to one or more applications on a mobile device that returns a pose (position and orientation) of the mobile device in real-time and with high-accuracy. In other aspects, the present disclosure uses image data such, as for example StreetView™ image data and the mobile device's camera, combined with other sensors of the mobile device, to determine a real-time, highly accurate pose. In further aspects, new image features automatically extracted from user-generated images may be used to account for changed, variable, or previously occluded features of scenes in the mobile device's environment. In yet other aspects, user-generated images may be used to determine mobile device location in a manner that does not compromise the privacy of a user of the mobile device or of persons nearby.

The present disclosure introduces a system for automatically vetting image features by comparison with data from received multiple mobile device users, over time. A low-bandwidth, low-latency system for determining pose on a mobile device using its camera is also introduced. The present disclosure further introduces a system for using time-of-day information of features to handle time-specific features, such as night-time or day-time only features.

While an image is formed of a complete set of pixels, as in any standard joint picture expert group (JPEG) image, an image feature represents an “interesting point” in an image. Generally, an image feature can be found within an image, and described, with relative ease. The features may be chosen and described in a manner that changes very little under lighting changes, perspective changes, scale changes and rotation. This consistency and lack of change in image features is called “robustness”. Image features, then, represent points in an image that can be matched with features on another image taken from the same scene. A useful description of Scale-Invariant Feature Transform (SIFT), may be found at http://en.wikipedia.org/wiki/Scale-invariant_feature_transform, the contents of which is incorporated herein by reference. Besides SIFT, other processes may be used to define image features. As a non-limiting example, image features may be determined using Oriented FAST and Rotated Brief (ORB), described in http://www.willowgarage.com/sites/default/files/orb_final.pdf, the contents of which is incorporated herein by reference.

Storing, processing or transmitting image features usually take up much less data than storing, processing or transmitting the entire image. A feature may be described with as little as 64 bytes, including its location in the image and a description of the feature, called a “descriptor”. A two megabyte image could be represented with 100 features extracted from the image, in which case 6.4 k bytes would provide sufficient information for matching the entire image with a user provided image.

Features descriptions form one-way functions. Given a set of image features, it is not possible reconstruct the original image with any accuracy. Consequently, transmission of image features from a mobile device may be made while preserving the privacy of the mobile device's user.

Image features may be stored individually on a server so that non-useful or incorrect features can be selectively removed and individual new features can be easily added.

Both systematic images, for example StreetView™ images, and user-generated images may be used for determining location. The system includes a method for vetting and collecting user-generated image features to account for changing scenes caused by such events as renovations and decoration changes.

Estimating a camera's pose based on precisely located reference images is a well-known problem and various algorithms, such as for example bundle adjustment, are already capable of solving it. Most of these algorithms extract robust features from the images and use those features to compare the images.

Those of ordinary skill in the art will appreciate that the 3-D location of reference image features may be determined by triangulation using multiple reference images.

The reference images may be more precisely aligned and located using bundle adjustment or similar algorithms.

In the present text, both “feature” and “image feature” refer to a robust image feature with its descriptor that has been extracted from a camera image. If the same physical feature is visible in more than one image, “feature” may refer to the physical feature at a particular location which is visible in various images. It also includes, where appropriate, three dimensional (3-D) coordinates of the location from which the image was taken and the direction of the feature from that location. If available, it may include the distance of the feature from the location at which it was observed. Alternatively, it may include the full 3-D coordinates of the feature itself.

By using systematic, precisely geo-located images as a reference, the system may be able to determine an absolute pose of the mobile device with a high degree of accuracy in a wide variety of outdoor, and in some cases indoor, settings.

Uploading entire images from a mobile device to a server for the server to determine pose is expensive bandwidth-wise and slow. It also has serious privacy implications. On one hand, uploading image features detected in the image from a mobile device's camera to the server may allow determining pose by the server. This allows much higher-powered processing to be done on the server, but requires significant bandwidth may increase latency. On the other hand, image features may be downloaded from a server based on the mobile device's estimated location. The mobile device may then match these image features with features extracted from its own camera images. This solution provides lower latency pose determination, but requires significant processing power on the mobile device. Generally, current mobile devices such as modern phones and tablets possess sufficient computing power needed to extract relevant features images obtained from their camera and to compare those features to the ones received from the server to determine pose in a relatively short time, to thereby provide mobile users with a near real-time feel.

Of course, full images rather than image features may be downloaded from a server to a mobile client. For example, the mobile device may simply download Google™ StreetView™ images and the mobile device may attempt to find its location based on these images. This solution imposes larger bandwidth and mobile device processing requirements. In contrast, using image features facilitates filtering out transient or spurious environmental features, such as for example parked cars that may be present in full images in the server, but not in an image obtained in the mobile device, or vice-versa. It is thus easier for the server to add, modify or delete reference image features rather than modifying a complete image.

An image of a given environment may significantly change depending on time-of-day. For example, a neon sign may be very significant at night, but may be unremarkable during daytime. Image features may be based on image elements that remain invariable over time, between day and night or over seasonal changes. Alternatively, different sets of image features for a same location may be used depending on time-of-day or depending on the season. Image features may be tagged by the dates and times that they were observed. This allows the server to determine which features are, for example, only visible in daylight or only at night, as in the case of a neon sign. This analysis prevents the mobile device from needing to download or being confused by features that are not appropriate for the current time-of-day. The storing of dates and times with features also allows the server also to determine which features are stable over time and which ones have permanently disappeared.

In a variant of the present disclosure, the mobile device may detect and upload image features to the server. An amount of bandwidth required for uploading the image features should be reasonable. The server may calculate a precise location of the mobile device based on the uploaded image features and transmit the result to the mobile device. This solution may support a particular mobile device having less processing power.

Regardless of the manner in which location of the mobile device is determined, image-based pose determination may be combined with GPS, inertial, and magnetic sensors via a suitable process such as, but not limited to, a Kalman filter or a variant thereof. The filter may incorporate the data into its pose estimate in a manner that accounts for computation time elapsed during image processing and for alignment of other sensor data that has been received since the image was taken. Inputs to the filter may comprise data from various sensors including one or more of an accelerometer, a gyroscope and/or a magnetometer, along with image-derived pose. Each information element may be input into the filter as they become available. Outputs from the filter include the position and orientation of the device.

Image data is sometimes blurred, sometimes out of focus, and sometimes temporarily obscured. A Kalman filter, or similar filters such as an Extended Kalman Filter or Particle Filter, combines various noisy data sources to estimate an underlying state of a system, in this case, the pose of the mobile device. Using low latency inertial and magnetic sensors, the inputs may be combined provide an accurate estimate in real time. In fact, if image data becomes unavailable for a few seconds, the filter can continue to use data the other sensors, though some drift may occur due to imprecision in the sensor data.

In yet another variant, the Kalman filter may be “rewindable” to handle the fact that image data takes time to process, causing the image information input into the filter to actually represent the mobile device's position as it was several hundred milliseconds before. This is compensated by recording a state of the Kalman filter when the image is taken. Once the image data has been analyzed, the Kalman filter rewinds to that state, incorporating the pose estimation from image data, and is then played forward again to take into account sensor data received after the image was taken. Other linear or non-linear estimators can also be made to rewind in similar manner.

The use of inertial and magnetic sensors allows real-time accuracy in pose determination, as image-based pose determination can be temporarily blurred or obscured and may have a significant latency. The inertial and magnetic device sensors, on the other hand, are subject to drift and bias which the image-based pose determination is able to correct.

Individual mobile devices may report, either directly to the server or indirectly via the features they submit to the server, which features were useful for determining pose. They may also report any new features that might be useful to other mobile devices. The server may analyze this information to select robust features that are stable over time and fixed in position. The server is thus able to filter out transient features, such as those from parked cars, or movable features, such as sidewalk signs.

Those of ordinary skill in the art will realize that the description of the methods, mobile device and server for support of augmented reality on the mobile device are illustrative only and are not intended to be in any way limiting. Other embodiments will readily suggest themselves to such persons with ordinary skill in the art having the benefit of the present disclosure. Furthermore, the disclosed methods, mobile device and server may be customized to offer valuable solutions to existing needs and problems of providing augmented reality information.

In the interest of clarity, not all of the routine features of the implementations of methods, mobile device and server are shown and described. It will, of course, be appreciated that in the development of any such actual implementation of the methods, mobile device and server, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of augmented reality having the benefit of the present disclosure.

In accordance with the present disclosure, the components, process steps, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of process steps is implemented by a computer or a machine and those process steps may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method of determining a pose of a mobile device, comprising:
acquiring in the mobile device a current image of an environment of the mobile device; and
determining a location and an orientation of the mobile device by comparing the current image with reference image information related to an estimated location of the mobile device.

2. The method of claim 1, wherein the reference image information comprises a complete or partial reference image.

3. The method of claim 1, wherein the reference image information comprises features of one or more complete or partial reference images.

4. The method of claim 1, comprising:
detecting a new, modified or missing image feature in the current image; and
sending from the mobile device, toward a server, the new, modified or missing image feature.

5. The method of claim 1, wherein:
one or more sensors provide sensor information selected from the group consisting of an angular position of the mobile device relative to the horizon, an orientation of the mobile device relative to the magnetic North, an acceleration of the mobile device, an angular velocity of the mobile device, and a combination thereof; and
determining the location and the orientation of the mobile device further comprise refining the location and the orientation of the mobile device using the sensor information.

6. The method of claim 5, comprising applying the current image, the reference image information and the sensor information to a Kalman filter or other estimator.

7. The method of claim 1, comprising using a Kalman filter or other estimator to estimate pose using a comparison of the current image with reference image information.

8. The method of claim 1, comprising determining the location and the orientation of the mobile device in real-time.

9. The method of claim 1, comprising adding to the current image augmented reality information based on the determined location and the orientation of the mobile device.

10. A mobile device, comprising:
a camera for acquiring a current image of an environment of the mobile device; and
a processor for determining a location and an orientation of the mobile device by comparing the current image with reference image information related to an estimated location of the mobile device.

11. The mobile device of claim 10, wherein:
the processor is configured to detect a new, modified or missing image feature in the current image; and
the mobile device further comprises a transmitter for sending, toward a server, the new, modified or missing image feature.

12. The mobile device of claim 10, comprising:
one or more sensors for providing sensor information selected from the group consisting of an angular position of the mobile device relative to the horizon, an orientation of the mobile device relative to the magnetic North, an acceleration of the mobile device, an angular velocity of the mobile device and a combination thereof;
wherein the processor is configured refine the location and the orientation of the mobile device using the sensor information.

13. The mobile device of claim 12, comprising a sensor selected from the group consisting of a gyroscope, an accelerometer and a magnetometer.

14. The mobile device of claim 10, wherein the processor is configured to apply a Kalman filter or other estimator to compare the current image with reference image information.

15. The mobile device of claim 14, wherein the Kalman filter or other estimator is rewindable.

16. The mobile device of claim 10, wherein the processor is configured to determine the location and the orientation of the mobile device in real-time.

17. The mobile device of claim 10, wherein:
the processor is configured to add to the current image augmented reality information based on the determined location and orientation of the mobile device; and
the mobile device further comprises a display for showing the current image with the added augmented reality information.

18. A method of maintaining reference image information, comprising:
storing, in a server, reference image information in association with corresponding location information;
receiving, from a mobile device, an indication of a new, modified or missing reference image feature for a given location; and
incorporating, in the server, the new, modified or missing reference image feature corresponding to the given location.

19. The method of claim 18, comprising:
accumulating, in the server, a plurality of indications of the new, modified or missing reference image feature;
wherein updating the reference image feature corresponding to the given location follows reception of a predetermined number of indications.

20. The method of claim 19, wherein updating the reference image feature corresponding to the given location follows reception of the predetermined number of indications from a predetermined number of distinct mobile devices.

21. The method of claim 19, comprising:
recording times when the reference image features corresponding to the given location are updated;
receiving from a given mobile device, at the server, a request for reference image features for the given location;
selecting at the server, for the given location, reference image features having been stable for at least a predetermined period of time; and
sending toward the given mobile device, from the server, the selected reference image features.

22. A server, comprising:
a database for storing reference image information in association with corresponding location information;
a communication interface for receiving an indication of a new, modified or missing reference image feature for a given location; and
a processor for incorporating, in the database, the new, modified or missing reference image feature corresponding to the given location.

23. The server of claim 22, comprising:
a timer operably connected to the database for providing time values;
wherein:
the database is configured to record time values when reference image features corresponding to the given location are updated;
the interface is configured to receive a request for reference image features for the given location;
the processor is configured to select, for the given location, reference image features having been stable for at least a predetermined period of time; and
the interface is configured to send the selected reference image features.

24. The server of claim 22, wherein:
the database is configured to accumulate a plurality of indications of the new, modified or missing reference image feature;
wherein the processor is configured to update the reference image feature corresponding to the given location following accumulation of a predetermined number of indications in the database.
